(19) United States
(12) Patent Application Publication
(10) Pub. No.: US 2009/0118419 A1
(43) Pub. Date: May 7, 2009

(54) Material for use in contact with drinking water as well as having microbe-resistant properties

(76) Inventor: Uwe Maass, Hamburg (DE)

Correspondence Address: COLLARD & ROE, P.C., 1077 NORTHERN BOULEVARD, ROSLYN, NY, 11576, US

(21) Appl. No.: 10/577,209

(22) PCT Filed: May 21, 2005
(86) PCT No.: PCT/DE05/00931

§ 371 Date: Apr. 26, 2006

(30) Foreign Application Priority Data
Feb. 2, 2005 (DE) 10 2005 004 735.1

(51) Int. Cl. C08L 27/00

(52) U.S. Cl. 524/569; 524/567

(57) ABSTRACT

The invention relates to a material for use in contact with drinking water as well as having microbe-resistant properties, based on a vulcanized rubber mixture, comprising a rubber component as well as usual mixture ingredients, whereby according to the invention, the rubber component is butyl rubber or a halogenated rubber. This material is particularly used for the production of a hose that comprises a core and cover, particularly in connection with an embedded reinforcement support, whereby the material according to the invention is used at least for the core. In this connection, the core is preferably equipped with an additional inner layer of non-cross-linked polyethylene, whereby this inner layer is in direct contact with the drinking water.

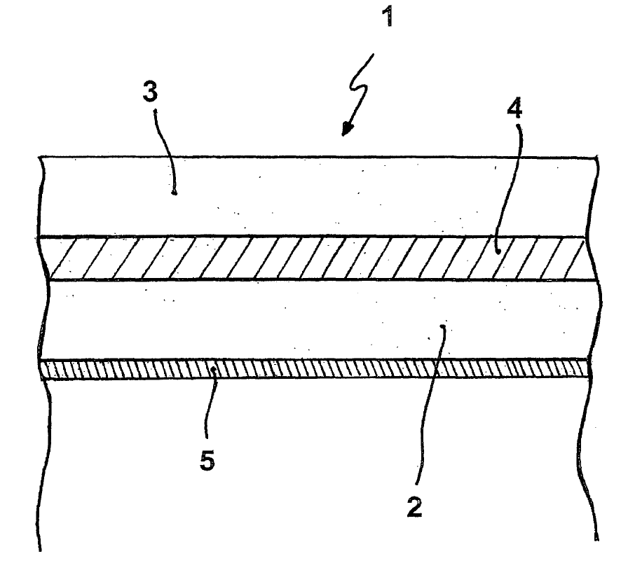

The invention relates to a material for use in contact with drinking water as well as having microbe-resistant properties, based on a vulcanized rubber mixture, comprising a rubber component as well as usual mixture ingredients.

It is known to use blends of nitrile rubber (NBR) and polyvinyl chloride (PVC) for elastic hoses for foods, specifically for conducting milk, whey, hot water up to 90°, edible oils, and vegetable juices. Such a hose for foods is known under the trademark TRIX-MULTI-FOOD® from PHOENIX AG.

Furthermore, a line for drinking water, made of plastic, is introduced in the Offenlegungsschrift WO 2004/110739 A1. This line comprises a base pipe consisting of a cross-linked or non-cross-linked polyolefin material, as well as of at least one polymer diffusion and wear protection layer, which can consist, for example, of polyamides, polyesters, or a poly(ethylene co-vinyl acetate).

With regard to a microbe-resistant material, reference is made, in particular, to the Offenlegungsschrift DE 102 58 551 A1, in which a sewage treatment settling basin is described. This consists of NBR, an ethylene-propylene-diene mixed polymerizate (EPDM), or silicone rubber. An EPDM/NBR blend is also used. This settling basin membrane, which is gas-permeable by means of perforation, is configured in such a manner that for the purpose of permanent gas permeability of the vulcanized rubber mixture, an active inhibitor, in terms of waste water biology, specifically in the form of a microorganism inhibitor and algae inhibitor, is mixed in.

Articles on the basis of a vulcanized rubber mixture that come into contact with drinking water are subjected to increasingly greater demands. For example, they are not allowed to exert any negative influence on the drinking water, particularly under the aspect of smell and taste, and further are not allowed to contribute to germ formation in the water. These demands are established, for example, in the requirements of the KTW [plastics for drinking water] recommendation, part 1.3.13, and the Work Sheet W270 of the DVGW [Deutsche Vereinigung des Gasund Wasserfaches=industry self-regulation in the gas and water supply industry].

With the background of this profile of high demands, the new material is characterized in that the rubber component is butyl rubber (IIR) or a halogenated rubber.

The halogenated rubber is, in particular, chlorobutyl rubber (CIIR) or bromobutyl rubber (BIIR). In this connection, the rubber component is preferably unblended, in each instance. The proportion of the rubber component is 30 to 70 wt.-%, particularly 40 to 55 wt.-%.

The rubber mixture has a filler or a filler system on the basis of carbon black and/or silicic acids and/or silicates and/or chalk. In particular, a filler system on the basis of carbon black, magnesium silicate, and chalk is used. The proportion of carbon black, in this connection, is maximally 30 wt.-%, particularly maximally 20 wt.-%.

Other mixture ingredients are a cross-linking agent and/or vulcanization activator or cross-linking agent system, processing aid, for example stearic acid, as well as anti-aging agents and stabilizers, if necessary. In this regard, reference is made to the general state of rubber mixture technology. In particular, zinc oxide (vulcanization activator) and zinc N-dibenzyl-dithiocarbamate (accelerator ZBEC) is used as a cross-linking agent system comprising a cross-linking agent and/or vulcanization activator.

The invention will now be presented in greater detail, using two exemplary embodiments (A; drinking water hose)—here in connection with a schematic representation—as well as (B; sewage treatment settling basin).
A) The sole figure (longitudinal section of a hose wall) shows a drinking water hose 1, comprising a core 2, a cover 3, an embedded reinforcement support 4, as well as an inner layer 5, which stands in direct contact with the drinking water.

The material according to the invention is now used at least for the core 2, whereby reference is made to the following composition of the rubber mixture.

| Component | Proportion in wt.-% |
|---|---|
| Bromobutyl rubber | 44.0 |
| Carbon black | 17.0 |
| Magnesium silicate | 26.0 |
| Chalk | 8.6 |
| Stearic acid | 0.5 |
| Zinc oxide | 3.5 |
| Accelerator ZBEC | 0.4 |
| | 100.00 |

The rubber mixture for the core 2 is free of plasticizers.

The cover 3 can have the same composition as the core 2. However, in most cases, a plasticizer is additionally mixed into it, the proportion of which is maximally 15 wt.-%, particularly maximally 10 wt.-%. In the present exemplary embodiment, the plasticizer proportion of the cover mixture is 7.6 wt.-%, whereby only the filler system, comprising the carbon black, the magnesium silicate, and the chalk, is reduced by this value, with the remainder of the composition remaining the same.

In this connection, the core mixture can stand in direct contact with the water, or can be affixed behind an inner layer 5 as a barrier layer. This inner layer in the form of a plastic film consists of polyethylene, which is particularly non-cross-linked.

If the hose 1 has additional layers, for example within the framework of a two-ply reinforcement support system having an intermediate layer, the cover mixture is used, in particular.

Here, the total mass in wt.-% relates to the hose part, in each instance (core, cover, intermediate layer).
B) The material according to the invention is used for the production of a settling basin membrane in the form of a plate membrane, hose membrane, or sheet aerator membrane, whereby the core mixture mentioned under the exemplary embodiment (A) can be used, for example.

With regard to permanent gas permeability, an active inhibitor, in terms of waste water biology, is mixed into the material. For details, reference is made to the Offenlegungsschrift DE 102 58 551 A1.

### REFERENCE SYMBOL LIST

1 hose (drinking water hose)
2 core
3 cover
4 reinforcement support
5 inner layer (plastic film)

1. Material for use in contact with drinking water as well as having microbe-resistant properties, based on a vulcanized rubber mixture, comprising a rubber component as well as usual mixture ingredients, wherein the rubber component is butyl rubber or a halogenated rubber.

2. Material according to claim 1, wherein the halogenated rubber is chlorobutyl rubber or bromobutyl rubber.

3. Material according to claim 1 wherein the rubber component is unblended.

4. Material according to claim 1, wherein the proportion of the rubber component is 30 to 70 wt.-%.

5. Material according to claim 4, wherein the proportion of the rubber component is 40 to 55 wt.-%.

6. Material according to claim 1, wherein the rubber mixture has a filler or a filler system on the basis of carbon black and/or silicic acids and/or silicates and/or chalk.

7. Material according to claim 6, wherein the rubber mixture has a filler system on the basis of carbon black, magnesium silicate, and chalk.

8. Material according to claim 6 wherein the proportion of carbon black is maximally 30 wt.-%.

9. Material according to claim 8, wherein the proportion of carbon black, is maximally 20 wt.-%.

10. Material according to claim 1, wherein the rubber mixture has a cross-linking system comprising a cross-linking agent and/or vulcanization agent as well as accelerator.

11. Material according to claim 10, wherein the cross-linking agent system comprises zinc oxide as a vulcanization activator and zinc N-dibenzyl-dithiocarbamate as an accelerator.

12. Material according to claim 1, wherein the rubber mixture is low in plasticizer, particularly free of plasticizer.

13. Use of the material according to claim 1 for the production of a hose (1) comprising a core (2) and cover (3), particularly in connection with an embedded reinforcement support (4), as well as additional layers, if necessary, whereby in terms of material, at least the core is used for use in contact with drinking water, as well as equipped with microbe-resistant properties.

14. Use of the material according to claim 13, whereby the rubber mixture for the core (2) is low in plasticizer, particularly free of plasticizer.

15. Use of the material according to claim 13, whereby the rubber mixture for the cover (3) has a plasticizer.

16. Use of the material according to claim 15, whereby the proportion of the plasticizer is maximally 15 wt.-%.

17. Use of the material according to claim 16, whereby the proportion of the plasticizer is maximally 10 wt.-%.

18. Use of the material according to claim 13, whereby the core (2) is equipped with an inner layer (5), particularly a film layer, which stands directly in contact with the drinking water.

19. Use of the material according to claim 18, whereby the inner layer (5) consists of plastic, particularly polyethylene, which in turn is particularly non-cross-linked.

20. Use of the material according to claim 1 for the production of a membrane, particularly a settling basin membrane.

21. Use of the material according to claim 20, whereby the rubber mixture is low in plasticizer, particularly free of plasticizer, for the entire membrane.

22. Use of the material according to claim 20, whereby the rubber mixture additionally contains an active inhibitor in terms of waste water technology.
